(19) United States
(12) Patent Application Publication
(10) Pub. No.: US 2026/0016050 A1
(43) Pub. Date: Jan. 15, 2026

(54) VEHICULAR WHEEL BEARING HAVING IMPROVED SEALING PROPERTY

(71) Applicant: ILJIN GLOBAL Co.,Ltd, Seoul (KR)

(72) Inventors: Deok Hwa SEO, Seoul (KR); Seong Kyu JIN, Seoul (KR); In Jun KANG, Seoul (KR); Yong Won KIM, Seoul (KR)

(73) Assignee: ILJIN GLOBAL Co.,Ltd, Seoul (KR)

(21) Appl. No.: 19/266,330

(22) Filed: Jul. 11, 2025

(30) Foreign Application Priority Data
Jul. 11, 2024 (KR) 10-2024-0091862

(51) Int. Cl. F16C 33/80; F16C 19/18

(52) U.S. Cl. CPC F16C 33/805; F16C 19/18; F16C 2326/02

(57) ABSTRACT

A vehicular wheel bearing includes a wheel hub on which the wheel of the vehicle is mounted and configured to rotate together with the wheel of the vehicle; at least one inner ring mounted on the wheel hub; an outer ring coupled and secured to a vehicle-body-side member; a plurality of rolling elements configured to rotatably support the wheel hub and the inner ring relative to the outer ring; an inboard-side sealing member configured to perform sealing at an axial inner end portion of a bearing space in which the plurality of rolling elements are disposed; and an outboard-side sealing member configured to perform sealing at an axial outer end portion of the bearing space in which the plurality of rolling elements are disposed.

### CROSS-REFERENCE TO RELATED APPLICATION

This application claims priority to Korean Patent Application No. 10-2024-0091862 filed on Jul. 11, 2024, the entire contents of which are herein incorporated by reference.

### TECHNICAL FIELD

The present disclosure relates to a vehicular wheel bearing which supports a wheel of a vehicle while rotatably mounting the wheel on a vehicle body, and more particularly, to a vehicular wheel bearing in which a structure of an end portion of a frame on which an over-molded portion is formed is improved to enhance a manufacturing property and sealing property of a sealing member.

### BACKGROUND ART

A wheel bearing is a device which supports a wheel of a vehicle while rotatably mounting the wheel to a vehicle body, and is configured such that rotary elements on which the wheel of the vehicle is mounted are connected to a non-rotary element fixed to the vehicle body via rolling elements to perform a function of rotatably supporting the wheel of the vehicle to the vehicle body.

Since the wheel bearing is used while being mounted on the wheel of the vehicle, the wheel bearing is likely to be exposed to external foreign matters such as mud and moisture. Therefore, in order to prevent the external foreign matters from being introduced into the wheel bearing, a sealing member(s) may be mounted to the wheel bearing.

With reference to FIG. 1, there is exemplarily illustrated a structure of a vehicular wheel bearing with a sealing member.

As illustrated in FIG. 1, a vehicular wheel bearing 10 may be configured such that rotary elements (for example, a wheel hub 20 and an inner ring 30) which rotate together with a wheel of a vehicle are rotatably mounted on a non-rotary element (for example, an outer ring 40) fixed to a vehicle body via rolling elements 50. A sealing member(s) 60 may be mounted between the rotary elements and the non-rotary element of the wheel bearing to prevent external foreign matters from flowing into the wheel bearing or prevent internal grease from leaking to the outside.

Referring to FIG. 2, there is exemplarily illustrated a structure of an outboard-side sealing member 60 (open-type sealing member) which may be used for the vehicular wheel bearing 10.

As illustrated in FIG. 2, the sealing member 60 (the open-type sealing member) may be configured to comprise a frame 70 mounted on the outer ring 40 in a press-fitting manner and an elastic sealing portion 80 attached integrally to the frame 70. A sealing lip 82 provided in the elastic sealing portion 80 may be in contact with or disposed near to a counterpart to perform sealing.

On the other hand, the elastic sealing portion 80 comprises an over-molded portion 84 configured to surround an outer end portion 72 of the frame 70. The over-molded portion 84 comes into close contact with the outer ring 40 to prevent external foreign matters from being introduced inward of a press-fitting surface of the sealing member 60.

Here, in the sealing member 60 configured as above, the outer end portion 72 of the frame 70 on which the over-molded portion 84 is formed in a short cut structure. This makes it difficult to sufficiently provide a support force with respect to the over-molded portion 84, which may cause a decrease in sealing property. Further, since the outer end portion 72 of the frame 70 is formed without a sufficient step, the elastic sealing portion 80 to be separated from a mold after molding may adhere to the mold. This may cause a degradation in manufacturing property.

### SUMMARY

### Technical Problem

The present disclosure was made to solve the above-mentioned matters, and the present disclosure is for the purpose of providing a vehicular wheel bearing configured such that a structure of an end portion of a frame on which an over-molded portion is formed is improved to enhance a manufacturing property and sealing property of a sealing member.

### Technical Solution

Representative configurations of the present disclosure to achieve the above aspects are as follows.

According to an example embodiment of the present disclosure, a vehicular wheel bearing for supporting a wheel of a vehicle while rotatably mounting the wheel to a vehicle body may be provided. The vehicular wheel bearing according to an example embodiment of the present disclosure may comprise: a wheel hub on which the wheel of the vehicle is mounted and configured to rotate together with the wheel of the vehicle; at least one inner ring mounted on the wheel hub; an outer ring coupled and secured to a vehicle-body-side member; a plurality of rolling elements configured to rotatably support the wheel hub 200 and the inner ring relative to the outer ring; an inboard-side sealing member configured to perform sealing at an axial inner end portion of a bearing space in which the plurality of rolling elements are disposed; and an outboard-side sealing member configured to perform sealing at an axial outer end portion of the bearing space in which the plurality of rolling elements are disposed. According to an example embodiment of the present disclosure, the outboard-side sealing member may comprise a frame mounted on the outer ring in a press-fitting manner and an elastic sealing portion attached integrally to the frame. According to an example embodiment of the present disclosure, the frame may comprise a press-fitting portion, a flange portion formed to be bent and extend radially inward from the press-fitting portion, and a bent portion formed to be bent and extend radially outward from the press-fitting portion. According to an example embodiment of the present disclosure, the elastic sealing portion may comprise a base portion configured to partially or entirely surround the frame, one or more sealing lips formed to extend from the base portion, and the over-molded portion configured to surround the bent portion of the frame. According to an example embodiment of the present disclosure, a radial outer end portion of the bent portion of the frame may be located radially outward from an outer circumferential surface of the press-fitting portion of the frame, and a radial height from the outer circumferential surface of the press-fitting portion of the frame to the radial outer end portion of the bent portion of the frame may be set to be equal to or greater than 0.3 millimeter (mm).

According to an example embodiment of the present disclosure, a radial height from an inner circumferential surface of the press-fitting portion of the frame to the radial outer end portion of the bent portion of the frame may be set to be 1.5 and 3 times a thickness of the frame.

According to an example embodiment of the present disclosure, a corner portion having a rounded structure may be formed between the press-fitting portion and the bent portion of the frame.

According to an example embodiment of the present disclosure, an inner circumferential surface of the corner portion between the press-fitting portion and the bent portion of the frame may be formed in a rounded structure having a predetermined radius of curvature. The predetermined radius of curvature may be set to be 1.5 to 3 times the thickness of the frame.

According to an example embodiment of the present disclosure, an outer circumferential surface of the over-molded portion may be positioned radially outward from the outer circumferential surface of the elastic sealing portion positioned on the outer circumferential surface of the press-fitting portion of the frame.

According to an example embodiment of the present disclosure, the outboard-side sealing member may further comprise a slinger mounted on the wheel hub in a press-fitting manner. The one or more sealing lips of the elastic sealing portion may be partially or entirely in contact with or disposed near the slinger.

According to an example embodiment of the present disclosure, the elastic sealing portion may further comprise a shield portion formed to extend axially outward from the base portion.

According to an example embodiment of the present disclosure, the slinger may comprise a press-fitting portion, a radial extension portion formed to be bent and extend radially outward from the press-fitting portion, and an axial extension portion formed to be bent and extend axially inward from the radial extension portion.

According to an example embodiment of the present disclosure, the shield portion may be disposed to at least partially overlap the axial extension portion of the slinger at a radially outward direction.

According to an example embodiment of the present disclosure, the elastic sealing portion may further comprise a dam portion formed to extend in the radially outward direction from the base portion.

According to an example embodiment of the present disclosure, the wheel hub may comprise a wheel mounting flange formed to extend in the radially outward direction. The wheel mounting flange may comprise a recess formed to be depressed axially outward at an axial inner cross-section. The outboard-side sealing member may be partially received in the recess.

According to an example embodiment of the present disclosure, the recess of the wheel mounting flange may comprise a first recess positioned outward in a radial direction, and a second recess positioned inward in the radial direction. The second recess may be formed to be more depressed than the first recess in an axially outward direction.

According to an example embodiment of the present disclosure, at least a part of the slinger may be received and disposed in the second recess.

According to an example embodiment of the present disclosure, at least a part of the shield portion of the elastic sealing portion may be received and disposed in the second recess.

According to an example embodiment of the present disclosure, at least a part of the dam portion of the elastic sealing portion may be received and disposed in the first recess.

Further, the vehicular wheel bearing according to the present disclosure may further comprise other additional configurations without departing from the technical sprit of the present disclosure.

### Advantageous Effects

In a vehicular wheel bearing according to an example embodiment of the present disclosure, a structure in which an outer end portion of a frame of an outboard-side sealing member is formed in a structure with a sufficient step. Accordingly, when an elastic sealing portion is molded in the frame, the elastic sealing portion may be stably attached to the frame with a sufficient support force. Further, the elastic sealing member with the sealing portion thus molded may be easily separated from a mold in a stable manner. This makes it possible to improve a manufacturing property of the sealing member.

### BRIEF DESCRIPTION OF DRAWINGS

FIG. 1 exemplarily illustrates a structure of a vehicular wheel bearing in the related art.

FIG. 2 exemplarily illustrates an example of a sealing member (outboard-side sealing member) which may be used for a vehicular wheel bearing.

FIG. 3 exemplarily illustrates a structure of a vehicular wheel bearing according to an example embodiment of the present disclosure.

FIG. 4 exemplarily illustrates a sealing member (outboard-side sealing member illustrated by a section A in FIG. 3) of the vehicular wheel bearing illustrated in FIG. 3.

FIG. 5 illustrates experimental results obtained by comparing a sealing property of the sealing member of the vehicular wheel bearing according to an example embodiment of the present disclosure with that of a sealing member in the related art.

### DETAILED DESCRIPTION

Example embodiments of the present disclosure are exemplified for the purpose of describing the technical spirit of the present disclosure. The scope of the claims according to the present disclosure is not limited to the example embodiments described below or to the detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising” “including” “having” and the like used herein should be construed as open-ended terms encompassing the possibility of including other example embodiments.

The term “axial direction” used herein may be defined as a direction extending along a rotational central axis of a wheel bearing (the term “axially inward” refers to a direction toward the vehicle body and the term “axially outward” refers to a direction toward the wheel), the term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Further, in the following descriptions of the example embodiments, duplicate description(s) of the same or corresponding constituent elements may be omitted. However, even though a description(s) of any constituent element is omitted, such a constituent element is not intended to be excluded in any example embodiment.

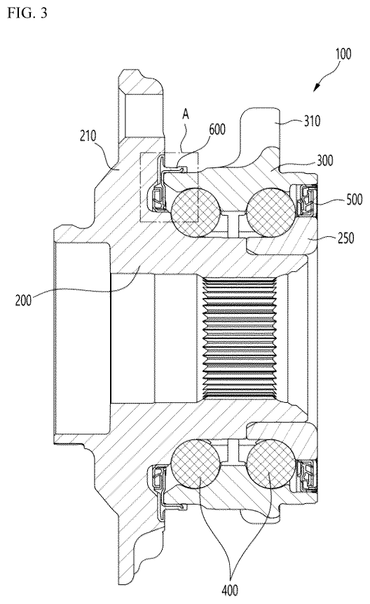

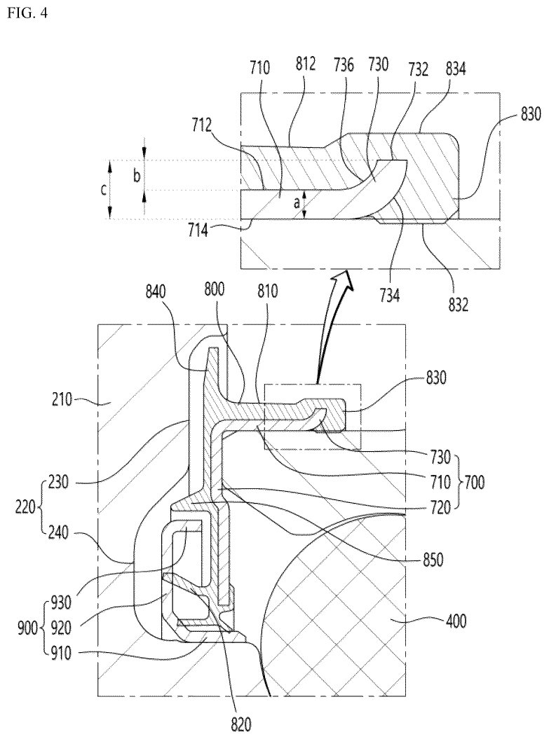

Referring to FIGS. 3 and 4, there are exemplarily illustrated structures of a vehicular wheel bearing according to an example embodiment of the present disclosure and a sealing member applicable to the vehicular wheel bearing.

As illustrated in the drawings, like a vehicular wheel bearing in the related art, a vehicular wheel bearing 100 according to an example embodiment of the present disclosure may be configured such that rotary elements (for example, a wheel hub 200 and an inner ring 250) are connected to a non-rotary element (for example, an outer ring 300) via rolling elements 400 to rotatably support the wheel of the vehicle relative to the vehicle body.

According to an example embodiment of the present disclosure, the wheel hub 200 constituting the rotary elements of the vehicular wheel bearing 100 may be formed in a substantially cylindrical shape extending along the axial direction as a whole. An outer circumferential surface of the wheel hub 200 may be provided with a wheel mounting flange (hub flange) 210. The wheel mounting flange 210 may be formed in a shape extending radially outward from the outer circumferential surface of the wheel hub 200 and may be used to mount the wheel of the vehicle on the wheel hub 200 with hub bolts or the like. Further, the inner ring 250 may be mounted on a vehicle-body-side end portion of the wheel hub 200. A raceway surface (inner raceway surface) may be formed on a portion of the outer circumferential surface of the wheel hub 200 to support the rolling elements 400 from a radially inward direction.

According to an example embodiment of the present disclosure, at least one inner ring 250 may be mounted on the outer circumferential surface of the wheel hub 200. A raceway surface for the rolling elements 400 may be formed on an outer circumferential surface of the inner ring 250 to support the rolling elements 400 from the radially inward direction. For example, the inner ring 250 may be mounted on a seating portion provided at the vehicle-bodyside end portion of the wheel hub 200 in a press-fitting manner, and may be configured to be supported by and fixed to the wheel hub 200 while a predetermined preload is applied thereto.

According to an example embodiment of the present disclosure, the outer ring 300 constituting the non-rotary element 300 of the vehicular wheel bearing 100 may comprise a vehicle-body-side mounting flange formed on an outer circumferential surface thereof to mount the wheel bearing on the vehicle body. The outer ring 300 may be configured to have a raceway surface (outer raceway surface) formed on an inner circumferential surface thereof and in contact with the rolling elements 400. The raceway surface (outer raceway surface) formed on the inner circumferential surface of the outer ring 300 may be configured to accommodate and support the rolling elements 400 as rolling members between the outer raceway surface and the inner raceway surface in cooperation with the raceway surface (inner raceway surface) formed on the wheel hub 200 and/or the inner ring 250.

According to an example embodiment of the present disclosure, the rolling elements 400 may be disposed between the rotary elements (for example, the wheel hub 200 and the inner ring 250) and the non-rotary element (for example, the outer ring 300) of the vehicular wheel bearing 100 to perform a function of rotatably supporting the rotary elements of the vehicular wheel bearing 100 relative to the non-rotary element.

However, the above-described configurations of the vehicular wheel bearing 100 according to an example embodiment of the present disclosure are limited to those described with reference to the drawings, but may be modified into various structures which may be applied to the vehicular wheel bearing.

For example, in the case of the example embodiments illustrated in the drawings, the vehicular wheel bearing has been described to have a configuration in which one raceway surface for supporting the rolling elements is directly formed on a portion of the outer circumferential surface of the wheel hub, but the vehicular wheel bearing according to an example embodiment of the present disclosure is not limited thereto. Alternatively, the vehicular wheel bearing may be modified to have other various configurations, such as a configuration in which a plurality of inner rings 250 are mounted on the wheel hub 200 to support the rolling elements 400.

Further, in the case of the example embodiment illustrated in the drawings, the rolling elements 400 which rotatably supports the rotary elements of the wheel bearing relative to the non-rotary element are formed with a spherical ball member, but may be formed in other shapes, such as tapered rollers.

According to an example embodiment of the present disclosure, a sealing member(s) may be provided on both sides of the vehicular wheel bearing 100 to prevent external foreign matters from flowing into a bearing space in which the rolling elements 400 are disposed or prevent grease (lubricant) filled into the bearing space from leaking to the outside.

According to an example embodiment of the present disclosure, an inboard-side sealing member 500 may be provided in an axial inner end portion of the bearing space in which the rolling elements 400 are disposed to perform sealing. An outboard-side sealing member 600 may be provided in an outer axial end portion of the bearing space in which the rolling elements 400 are disposed to perform sealing.

According to an example embodiment of the present disclosure, the inboard-side sealing member 500 may be formed to be substantially the same or similar to an inboard-side sealing member used for a typical vehicular wheel bearing. The vehicular wheel bearing 100 according to an example embodiment of the present disclosure does not have a feature(s) in a specific structure of the inboard-side sealing member 500, and therefore a detailed description thereof is omitted.

Referring to FIG. 4, there is exemplarily illustrated a structure of the outboard-side sealing member 600 (for example, an open-type sealing member) which may be used for the vehicular wheel bearing 100 according to an example embodiment of the present disclosure.

According to an example embodiment of the present disclosure, the outboard-side sealing member 600 may be configured to comprise a frame 700 mounted on the outer ring 300 in a press-fitting manner, and an elastic sealing portion 800 attached integrally to the frame 700.

According to an example embodiment of the present disclosure, the frame 700 constitutes a basic body of the outboard-side sealing member 600 and may be formed by bending a metal plate or the like.

According to an example embodiment of the present disclosure, the frame 700 of the outboard-side sealing member 600 may be configured to comprise a press-fitting portion 710, a flange portion 720 formed to be bent and extend radially inward from the press-fitting portion 710, and a bent portion 730 formed to be bent and extend radially outward from the press-fitting portion 710.

According to an example embodiment of the present disclosure, as illustrated in the drawings, the press-fitting portion 710 of the frame 700 may be formed in a substantially cylindrical structure and may be configured to be mounted on the outer circumferential surface of the outer ring 300 at an axial outer end portion of the outer ring 300 in a press-fitting manner.

According to an example embodiment of the present disclosure, the flange portion 720 of the frame 700 may be configured to be formed by bending radially inward at an axial outer end portion of the press-fitting portion 710. A portion of the flange portion 720 of the frame 700 may be configured to come into contact with an outer axial cross-section of the outer ring 300 and cover the outer axial cross-section of the outer ring 300.

According to an example embodiment of the present disclosure, the bent portion 730 of the frame 700 may be configured to be formed by bending radially outward at an axial inner end portion of the press-fitting portion 710. As will be described later, a radial outer end portion 732 of the bent portion 730 may be located radially outward by a predetermined height from an outer circumferential surface 712 of the press-fitting portion 710. Thus, a suitable height of stepped portion may be provided at an end portion of the frame 700 by the bent portion 730.

According to an example embodiment of the present disclosure, a radial height b from the outer circumferential surface 712 of the press-fitting portion 710 of the frame 700 to the radial outer end portion 732 of the bent portion 730 of the frame 700 may be set to be equal to or greater than 0.3 millimeter (mm).

According to an example embodiment of the present disclosure, a radial height c from an inner circumferential surface 714 of the press-fitting portion 710 of the frame 700 to the radial outer end portion 732 of the bent portion 730 of the frame 700 may be set to be 1.5 and 3 times a thickness of the frame 700 (for example, a thickness a of the press-fitting portion 710 of the frame 700).

According to an example embodiment of the present disclosure, the thickness a of the frame 700 (for example, the thickness a of the press-fitting portion 710 of the frame 700) may be set in a range of 0.2 mm to 2 mm.

As described above, the vehicular wheel bearing 100 according to an example embodiment of the present disclosure may be configured such that the end portion (the bent portion 730) of the frame 700 on which the over-molded portion 830 is formed in the outboard-side sealing member 600 is formed in a structure having the suitable height of stepped portion. Thus, when the elastic sealing portion 800 is molded in the frame 700, the elastic sealing portion 800 may be stably and easily attached to and formed on the frame 700. As a result, the frame 700 in which the elastic sealing portion 800 is molded may be easily and stably separated from a mold.

Further, the outboard-side sealing member 600 of the vehicular wheel bearing 100 according to an example embodiment of the present disclosure may be configured such that the bent portion 730 of the frame 700 has an increased height of stepped portion. This may increase a radial height of the over-molded portion 830 which surrounds the bent portion 730, thereby improving a sealing property.

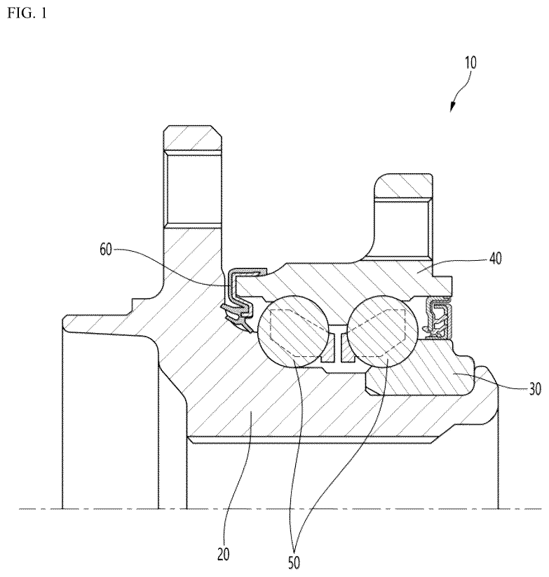

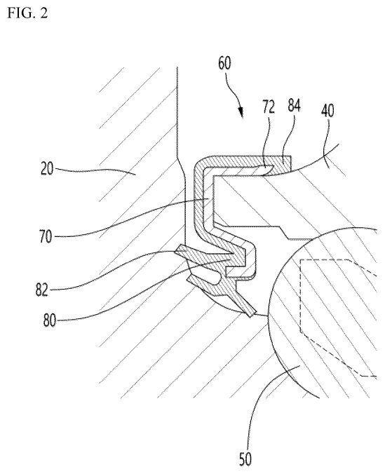

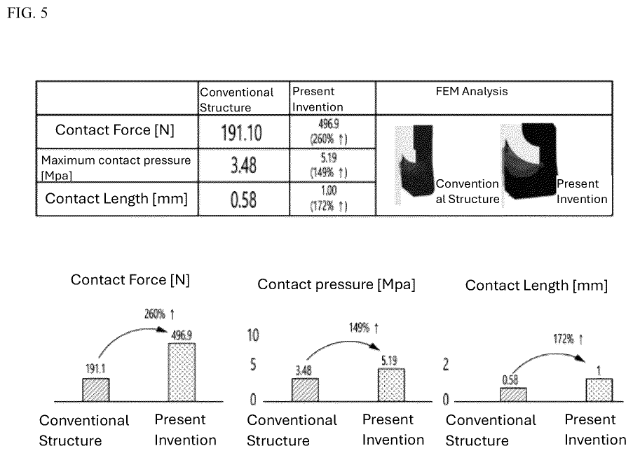

For example, referring to FIG. 5, there are exemplarily illustrated experimental results obtained by comparing a sealing property of the sealing member (having the structure illustrated in FIGS. 1 and 2) in the related art with the sealing property of the outboard-side sealing member 600 according to an example embodiment of the present disclosure.

As illustrated in FIG. 5, it was found that, since the outboard-side sealing member 600 according to an example embodiment of the present disclosure is configured such that the bent portion 730 of the frame 700 has the increased height of stepped portion and consequently the radial height of the over-molded portion 830 is increased, the elastic sealing portion 800 may have a significantly increased contact force, contact pressure, and contact length. Accordingly, it is possible to provide a significantly improved sealing property compared with that in the related art.

According to an example embodiment of the present disclosure, a corner portion having a rounded structure may be formed between the press-fitting portion 710 and the bent portion 730 of the frame 700.

According to an example embodiment of the present disclosure, an inner circumferential surface 734 of the corner portion between the press-fitting portion 710 and the bent portion 730 of the frame 700 may be formed in a rounded structure having a predetermined radius of curvature R. Preferably, the predetermined radius of curvature R of the inner circumferential surface 734 of the corner portion may be set to be 1.5 to 3 times the thickness a of the frame 700.

According to an example embodiment of the present disclosure, an outer circumferential surface 736 of the corner portion between the press-fitting portion 710 and the bent portion 730 of the frame 700 may be formed in a rounded structure having a predetermined radius of curvature r.

According to an example embodiment of the present disclosure, the corner portion between the press-fitting portion 710 and the bent portion 730 of the frame 700 may be formed such that the predetermined radius of curvature r of the outer circumferential surface 736 is smaller than the predetermined radius of curvature R of the inner circumferential surface 734.

For example, according to the example embodiments illustrated in the drawings, the corner portion between the press-fitting portion 710 and the bent portion 730 of the frame 700 may be formed such that the inner circumferential surface 734 has the radius of curvature R of 1.0 mm to 1.4 mm and the outer circumferential surface 736 has the radius of curvature r of 0.6 mm to 1.0 mm.

According to an example embodiment of the present disclosure, the elastic sealing portion 800 of the outboard-side sealing member 600 may be formed of an elastic material such as rubber, and may be configured to be attached integrally to the frame 700 using, for example, a vulcanization.

According to an example embodiment of the present disclosure, the elastic sealing portion 800 may be configured to comprise a base portion 810 which partially or entirely surrounds the frame 700, one or more sealing lips 820 formed to extend from the base portion 810, and the over-molded portion 830 which surrounds the bent portion 730 located at an axial inner end portion of the press-fitting portion 710 of the frame 700.

According to an example embodiment of the present disclosure, as illustrated in FIG. 4, the base portion 810 of the elastic sealing portion 800 may be formed to extend from an inner end portion to an outer end portion of the frame 700 in the radial direction so as to entirely cover an axial outer cross-section and a radial outer cross-section of the frame 700.

According to an example embodiment of the present disclosure, the sealing lip(s) 820 of the elastic sealing portion 800 may be configured such that an end portion of the sealing lip(s) is in contact with or is disposed near a counterpart (the wheel hub 200 or a slinger 900 mounted on the wheel hub 200 in the case of the example embodiment illustrated in FIG. 4) to perform sealing.

According to an example embodiment of the present disclosure, the sealing lip(s) 820 may be implemented with a contact-type sealing lip which is in contact with the counterpart to perform sealing in a contact manner, a contactless-type sealing lip which is disposed near the counterpart to perform sealing in a non-contact manner, a combination of the contact-type sealing lip and the contactless-type sealing lip, or the like.

According to an example embodiment of the present disclosure, the over-molded portion 830 of the elastic sealing portion 800 may be formed in a structure that extends beyond the axial inner end portion of the frame 700 and surrounds the bent portion 730 of the frame 700. A part of the over-molded portion 830 may be sandwiched between the bent portion 730 of the frame 700 and the outer circumferential surface of the outer ring 300 such that the outboard-side sealing member 700 is stably brought into close contact with and mounted on the outer ring 300.

According to an example embodiment of the present disclosure, the inner circumferential surface 832 of the over-molded portion 830 may be positioned radially inward from the inner circumferential surface 714 of the press-fitting portion 710 of the frame 700.

With this configuration, when mounting the sealing member, the over-molded portion 830 may be elastically sandwiched in a compressed state between the bent portion 730 of the frame 700 and the outer circumferential surface of the outer ring 300. This makes it possible to further improve a mounting capability and a sealing property of the sealing member.

According to an example embodiment of the present disclosure, the outer circumferential surface 834 of the over-molded portion 830 may be positioned radially outward from the outer circumferential surface 812 of the base portion 810, which is attached to the outer circumferential surface 712 of the press-fitting portion 710 of the frame 700.

According to an example embodiment of the present disclosure, the elastic sealing portion 800 of the outboard-side sealing member 600 may further comprise a dam portion 840 formed to extend radially outward from the base portion 810.

According to an example embodiment of the present disclosure, the dam portion 840 may be disposed to face the wheel mounting flange 210 of the wheel hub 200 at an entrance of the outboard-side sealing member 600 to further prevent external foreign matters from entering the sealing member.

According to an example embodiment of the present disclosure, the outboard-side sealing member 600 may further comprise a slinger 900 which is mounted on the outer circumferential surface of the wheel hub 200 in a press-fitting manner and is configured to perform sealing in cooperation with the elastic sealing portion 800.

According to an example embodiment of the present disclosure, the slinger 900 may be configured to comprise a press-fitting portion 910 mounted on the outer circumferential surface of the wheel hub 200 in a press-fitting manner, and a radial extension portion 920 formed to be bent and extend radially outward from the press-fitting portion 910.

According to an example embodiment of the present disclosure, the sealing lips 820 of the elastic sealing portion 800 may be configured to be partially or entirely in contact with or be disposed near the press-fitting portion 910 and/or the radial extension portion 920 of the slinger 900 to perform sealing.

According to an example embodiment of the present disclosure, the slinger 900 may be configured to further comprise an axial extension portion 930 formed to be bent and extend axially inward at a radial outer end portion of the slinger 900.

According to an example embodiment of the present disclosure, the elastic sealing portion 800 may be configured to further comprise a shield portion 850 formed to extend axially outward from the base portion 810 at the entrance of the sealing member.

According to an example embodiment of the present disclosure, the shield portion 850 may be disposed to at least partially overlap the axial extension portion 930 of the slinger 900 at a radially outward direction.

With this configuration, a bent labyrinth structure may be formed at the entrance of the outboard-side sealing member 600 by the shield portion 850 of the elastic sealing portion 800 and the axial extension portion 930 of the slinger 900. The labyrinth structure may prevent external foreign matters from entering the sealing member in a more stable manner.

According to an example embodiment of the present disclosure, the wheel mounting flange (the hub flange) 210 of the wheel hub 200 may comprise a recess 220 formed to be depressed axially outward at an axial inner cross-section. The outboard-side sealing member 600 described above may be partially or entirely disposed to be received in the recess 220.

For example, according to an example embodiment of the present disclosure, as illustrated in FIG. 4, the outboard-side sealing member 600 may be configured such that an axial outer end portion thereof is partially received in the recess 220 provided in the wheel mounting flange 210 of the wheel hub 200.

According to an example embodiment of the present disclosure, the recess 220 may have a first recess 230 positioned outward in the radial direction and a second recess 240 positioned inward in the radial direction. The second recess 240 positioned inward in the radial direction may be formed to be more depressed than the first recess 230 in an axially outward direction.

According to an example embodiment of the present disclosure, at least a part of the dam portion 840 of the elastic sealing portion 800 may be received and disposed in the first recess 230 provided in the wheel mounting flange 210.

According to an example embodiment of the present disclosure, at least a part of the slinger 900 may be received and disposed in the second recess 240 provided in the wheel mounting flange 210.

According to an example embodiment of the present disclosure, at least a part of the shield portion 850 of the elastic sealing portion 800 may be received and disposed in the second recess 240 provided in the wheel mounting flange 210. The shield portion 850 of the elastic sealing portion 800 may be disposed to face an upper surface of the second recess 240 to form an additional labyrinth structure inside the sealing member.

Although the present disclosure has been described above in terms of specific items such as detailed constituent elements as well as the limited example embodiments and the drawings, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be the to belong to the scope and spirit of the present disclosure.

### EXPLANATION OF REFERENCE NUMERALS

100: Vehicular wheel bearing
200: Wheel hub
210: Wheel mounting flange (hub flange)
220: Recess
230: First recess
240: Second recess
300: Outer ring
310: Vehicle-side mounting flange
400: Rolling element
500: Inboard-side sealing member
600: Outboard-side sealing member
700: Frame
710: Press-fitting portion (of frame)
720: Flange portion (of frame)
730: Bent portion (of frame)
800: Elastic sealing portion
810: Base portion
820: Sealing lip
830: Over-molded portion
840: Dam portion
850: Shield portion
900: Slinger
910: Press-fitting portion (of slinger)
920: Radial extension portion (of slinger)
930: Axial extension portion (of slinger)
a: Thickness of frame
b: Radial height from outer circumferential surface of press-fitting portion of frame to radial outer end portion of bent portion of frame
c: Radial height from inner circumferential surface of press-fitting portion of frame to radial outer end portion of bent portion of frame
R: Radius of curvature of inner circumferential surface of corner portion between press-fitting portion and bent portion of frame
r: Radius of curvature of outer circumferential surface of corner portion between press-fitting portion and bent portion of frame

What is claimed is:

1. A vehicular wheel bearing (100) which supports a wheel of a vehicle while rotatably mounting the wheel on a vehicle body, the vehicular wheel bearing comprising:
a wheel hub (200) on which the wheel of the vehicle is mounted and configured to rotate together with the wheel of the vehicle;
at least one inner ring (250) mounted on the wheel hub (200);
an outer ring (300) coupled and secured to a vehicle-body-side member;
a plurality of rolling elements (400) configured to rotatably support the wheel hub (200) and the inner ring (250) relative to the outer ring (300);
an inboard-side sealing member (500) configured to perform sealing at an axial inner end portion of a bearing space in which the plurality of rolling elements (400) are disposed; and
an outboard-side sealing member (600) configured to perform sealing at an axial outer end portion of the bearing space in which the plurality of rolling elements (400) are disposed,
wherein the outboard-side sealing member (600) comprises a frame (700) mounted on the outer ring (300) in a press-fitting manner and an elastic sealing portion (800) attached integrally to the frame (700),
wherein the frame (700) comprises a press-fitting portion (710), a flange portion (720) formed to be bent and extend radially inward from the press-fitting portion (710), and a bent portion (730) formed to be bent and extend radially outward from the press-fitting portion (710),
wherein the elastic sealing portion (800) comprises a base portion (810) configured to partially or entirely surround the frame (700), one or more sealing lips (820) formed to extend from the base portion (810), and the over-molded portion (830) configured to surround the bent portion (730) of the frame (700),
wherein a radial outer end portion (732) of the bent portion (730) of the frame (700) is located radially outward from an outer circumferential surface (712) of the press-fitting portion (710) of the frame (700), and
wherein a radial height b from the outer circumferential surface (712) of the press-fitting portion (710) of the frame (700) to the radial outer end portion (732) of the bent portion (730) of the frame (700) is set to be equal to or greater than 0.3 millimeter (mm).

2. The vehicular wheel bearing of claim 1, wherein a radial height c from an inner circumferential surface (714) of the press-fitting portion (710) of the frame (700) to the radial outer end portion (732) of the bent portion (730) of the frame (700) is set to be 1.5 and 3 times a thickness a of the frame (700).

3. The vehicular wheel bearing of claim 1, wherein a corner portion having a rounded structure is formed between the press-fitting portion (710) and the bent portion (730) of the frame (700).

4. The vehicular wheel bearing of claim 3, wherein an inner circumferential surface (734) of the corner portion between the press-fitting portion (710) and the bent portion (730) of the frame (700) is formed in a rounded structure having a predetermined radius of curvature R, and
wherein the predetermined radius of curvature R is set to be 1.5 to 3 times the thickness a of the frame (700).

5. The vehicular wheel bearing of claim 1, wherein an outer circumferential surface (834) of the over-molded portion (830) is positioned radially outward from the outer circumferential surface 812 of the elastic sealing portion (800) positioned on the outer circumferential surface (712) of the press-fitting portion (710) of the frame (700).

6. The vehicular wheel bearing of claim 1, wherein the outboard-side sealing member (600) further comprises a slinger (900) mounted on the wheel hub (200) in a press-fitting manner, and wherein the one or more sealing lips (820) of the elastic sealing portion (800) are partially or entirely in contact with or disposed near the slinger (900).

7. The vehicular wheel bearing of claim 6, wherein the elastic sealing portion (800) further comprises a shield portion (850) formed to extend axially outward from the base portion (810).

8. The vehicular wheel bearing of claim 7, wherein the slinger (900) comprises a press-fitting portion (910), a radial extension portion (920) formed to be bent and extend radially outward from the press-fitting portion (910), and an axial extension portion (930) formed to be bent and extend axially inward from the radial extension portion (920).

9. The vehicular wheel bearing of claim 8, wherein the shield portion (850) is disposed to at least partially overlap the axial extension portion (930) of the slinger (900) at a radially outward direction.

10. The vehicular wheel bearing of claim 9, wherein the elastic sealing portion (800) further comprises a dam portion (840) formed to extend in the radially outward direction from the base portion (810).

11. The vehicular wheel bearing of claim 10, wherein the wheel hub (200) comprises a wheel mounting flange (210) formed to extend in the radially outward direction,
wherein the wheel mounting flange (210) comprises a recess (220) formed to be depressed axially outward at an axial inner cross-section, and
wherein the outboard-side sealing member (600) is partially received in the recess 220.

12. The vehicular wheel bearing of claim 11, wherein the recess (220) of the wheel mounting flange (210) comprises a first recess (230) positioned outward in a radial direction, and a second recess (240) positioned inward in the radial direction,
wherein the second recess (240) is formed to be more depressed than the first recess (230) in an axially outward direction.

13. The vehicular wheel bearing of claim 12, wherein at least a part of the slinger (900) is received and disposed in the second recess (240).

14. The vehicular wheel bearing of claim 13, wherein at least a part of the shield portion (850) of the elastic sealing portion (800) is received and disposed in the second recess (240).

15. The vehicular wheel bearing of claim 14, wherein at least a part of the dam portion (840) of the elastic sealing portion (800) is received and disposed in the first recess (230).
